(19) United States
(12) Patent Application Publication
(10) Pub. No.: US 2026/0045885 A1
(43) Pub. Date: Feb. 12, 2026

(54) ELECTRIC POWER CONVERSION APPARATUS AND ELECTRIC POWER CONVERSION SYSTEM

(71) Applicant: TDK CORPORATION, Tokyo (JP)

(72) Inventors: Kenta Terada, Tokyo (JP); Takamichi Sugawara, Tokyo (JP)

(73) Assignee: TDK CORPORATION, Tokyo (JP)

(21) Appl. No.: 19/272,564

(22) Filed: Jul. 17, 2025

(30) Foreign Application Priority Data
Aug. 7, 2024 (JP) 2024-130940

(51) Int. Cl. H02M 3/335; H02M 1/36

(52) U.S. Cl. CPC H02M 3/33573; H02M 1/36; H02M 3/33576

(57) ABSTRACT

An electric power conversion apparatus includes: first and second power terminals, a switching circuit, a voltage detection circuit, and a control circuit. The voltage detection circuit applies a predetermined voltage to a second node in a path coupling input and output nodes. The input node is coupled to a first node in the apparatus. The output node outputs a voltage corresponding to a voltage at the first node. In a second period before a first period, the control circuit controls a switching operation to cause electric power to be supplied from the second power terminal toward the first power terminal. In a third period before the second period, the control circuit controls the operation of the voltage detection circuit to cause the predetermined voltage to be applied to the second node, and diagnoses the voltage detection circuit, based on the voltage at the output node of the voltage detection circuit.

### CROSS-REFERENCE TO RELATED APPLICATIONS

The present application claims priority from Japanese Patent Application No. 2024-130940 filed on Aug. 7, 2024, the entire contents of which are hereby incorporated by reference.

### BACKGROUND

The disclosure relates to an electric power conversion apparatus and an electric power conversion system that each convert electric power.

Some of electric power conversion apparatuses perform a precharge operation upon start-up of a system. For example, Japanese Unexamined Patent Application Publication No. 2018-157662 discloses an electric power conversion apparatus that performs a precharge operation of charging a smoothing capacitor. In the electric power conversion apparatus, a voltage sensor that detects a voltage of the smoothing capacitor is diagnosed based on the voltage of the smoothing capacitor after starting of the precharge operation.

### SUMMARY

An electric power conversion apparatus according to one embodiment of the disclosure includes a first electric power terminal, a first switching circuit, a first transformer, a first rectifying circuit, a smoothing circuit, a second electric power terminal, a voltage detection circuit, and a control circuit. The first switching circuit is coupled to the first electric power terminal and configured to perform a switching operation. The first transformer includes a first winding and a second winding. The first winding is coupled to the first switching circuit. The first rectifying circuit is configured to rectify a voltage supplied from the second winding of the first transformer, by performing a switching operation. The smoothing circuit is coupled to the first rectifying circuit. The second electric power terminal is coupled to the smoothing circuit. The voltage detection circuit includes an input node and an output node. The input node is coupled to a first node in the electric power conversion apparatus. The output node is configured to output a voltage corresponding to a voltage at the first node. The voltage detection circuit is configured to apply a predetermined voltage to a second node in a signal path coupling the input node and the output node to each other. The control circuit is configured to control an operation of each of the voltage detection circuit, the first switching circuit, and the first rectifying circuit. The control circuit is configured to, in a second period before a first period in which electric power is to be supplied from the first electric power terminal toward the second electric power terminal, control the switching operation of the first switching circuit and the switching operation of the first rectifying circuit to cause electric power to be supplied from the second electric power terminal toward the first electric power terminal. The control circuit is configured to, in a third period before the second period, control the operation of the voltage detection circuit to cause the predetermined voltage to be applied to the second node, and diagnose the voltage detection circuit, based on a voltage at the output node of the voltage detection circuit in the third period.

An electric power conversion system according to one embodiment of the disclosure includes a first battery, a capacitor, a first switch, a second switch, an electric power conversion apparatus, and a second battery. The first battery includes a first terminal and a second terminal. The capacitor includes a first terminal and a second terminal. The first switch is provided in a path coupling the first terminal of the first battery and the first terminal of the capacitor to each other. The second switch is provided in a path coupling the second terminal of the first battery and the second terminal of the capacitor to each other. The electric power conversion apparatus includes a first electric power terminal, a first switching circuit, a first transformer, a first rectifying circuit, a smoothing circuit, a second electric power terminal, a voltage detection circuit, and a control circuit. The first electric power terminal includes a first coupling terminal and a second coupling terminal. The first coupling terminal is coupled to the first terminal of the capacitor. The second coupling terminal is coupled to the second terminal of the capacitor. The first switching circuit is coupled to the first electric power terminal and configured to perform a switching operation. The first transformer includes a first winding and a second winding. The first winding is coupled to the first switching circuit. The first rectifying circuit is configured to rectify a voltage supplied from the second winding of the first transformer, by performing a switching operation. The smoothing circuit is coupled to the first rectifying circuit. The second electric power terminal is coupled to the smoothing circuit and to the second battery. The voltage detection circuit includes an input node and an output node. The input node is coupled to a first node in the electric power conversion apparatus. The output node is configured to output a voltage corresponding to a voltage at the first node. The voltage detection circuit is configured to apply a predetermined voltage to a second node in a signal path coupling the input node and the output node to each other. The control circuit is configured to control an operation of each of the voltage detection circuit, the first switching circuit, and the first rectifying circuit. The control circuit is configured to, in a second period before a first period in which electric power is to be supplied from the first electric power terminal toward the second electric power terminal, control the switching operation of the first switching circuit and the switching operation of the first rectifying circuit to cause electric power to be supplied from the second electric power terminal toward the first electric power terminal. The control circuit is configured to, in a third period before the second period, control the operation of the voltage detection circuit to cause the predetermined voltage to be applied to the second node, and diagnose the voltage detection circuit, based on a voltage at the output node of the voltage detection circuit in the third period.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a circuit diagram illustrating a configuration example of an electric power conversion system according to one example embodiment of the disclosure.

FIG. 2 is a block diagram illustrating a configuration example of an auxiliary power supply circuit illustrated in FIG. 1.

FIG. 3 is an explanatory diagram illustrating an example of a precharge operation of the electric power conversion system illustrated in FIG. 1.

FIG. 4 is a timing waveform diagram illustrating an example of an operation of diagnosing a voltage detection circuit illustrated in FIG. 2.

FIG. 5 is a circuit diagram illustrating a configuration example of an electric power conversion system according to a modification example.

FIG. 6 is a block diagram illustrating a configuration example of an auxiliary power supply circuit illustrated in FIG. 5.

### DETAILED DESCRIPTION

What is desired of an electric power conversion apparatus is to effectively diagnose a voltage detection circuit, and expectations are placed on a more effective diagnosis of the voltage detection circuit.

It is desirable to provide an electric power conversion apparatus and an electric power conversion system that each make it possible to effectively diagnose a voltage detection circuit.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings. Note that the description is given in the following order.

### Example Embodiment

### Configuration Example

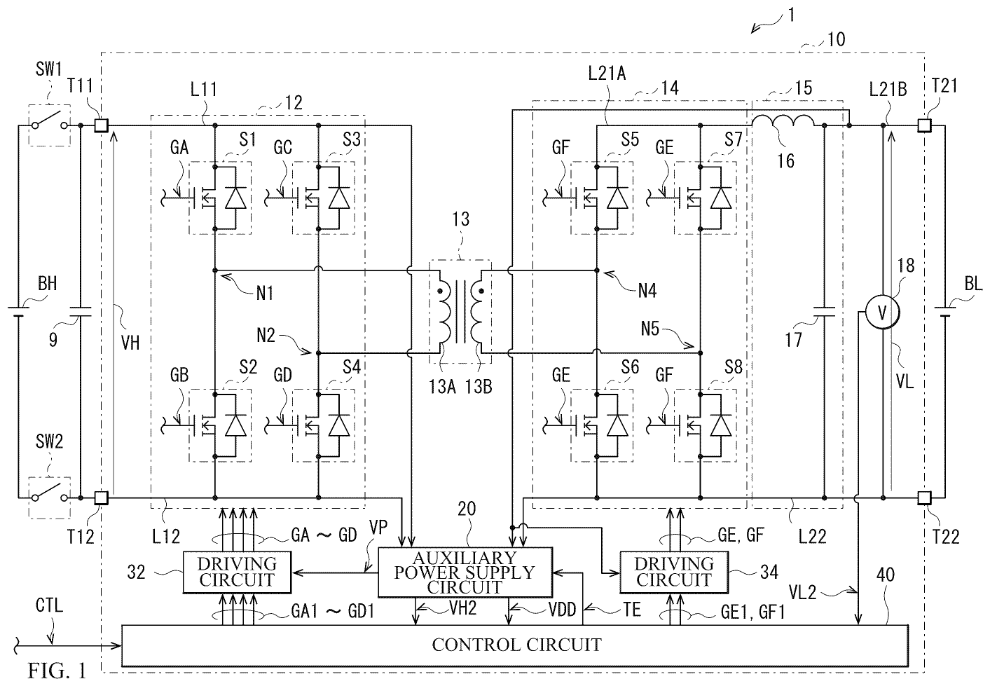

FIG. 1 illustrates a configuration example of an electric power conversion system 1 including an electric power conversion apparatus according to an example embodiment of the disclosure. The electric power conversion system 1 may include a high voltage battery BH, switches SW1 and SW2, a capacitor 9, an electric power conversion apparatus 10, and a low voltage battery BL. The electric power conversion system 1 may be configured to convert electric power supplied from the high voltage battery BH and to supply the converted electric power to the low voltage battery BL.

The high voltage battery BH may be configured to store electric power. The high voltage battery BH may supply the electric power to the electric power conversion apparatus 10 via the switches SW1 and SW2.

The switches SW1 and SW2 may be configured to, when turned on, allow the electric power stored in the high voltage battery BH to be supplied to the electric power conversion apparatus 10. The switches SW1 and SW2 may each include a relay, for example. When turned on, the switch SW1 may couple a positive terminal of the high voltage battery BH and a terminal T11 of the electric power conversion apparatus 10 to each other. When turned on, the switch SW2 may couple a negative terminal of the high voltage battery BH and a terminal T12 of the electric power conversion apparatus 10 to each other. The switches SW1 and SW2 may each be turned on or off in accordance with an instruction from an unillustrated system control processor.

The capacitor 9 may have a first end coupled to the terminal T11 of the electric power conversion apparatus 10 and to the switch SW1, and a second end coupled to the terminal T12 of the electric power conversion apparatus 10 and to the switch SW2.

The electric power conversion apparatus 10 may be configured to convert electric power by stepping down a voltage supplied from the high voltage battery BH, and to supply the converted electric power to the low voltage battery BL. The electric power conversion apparatus 10 may include the terminals T11 and T12, a switching circuit 12, a transformer 13, a rectifying circuit 14, a smoothing circuit 15, a voltage sensor 18, an auxiliary power supply circuit 20, driving circuits 32 and 34, a control circuit 40, and terminals T21 and T22. Primary-side circuitry of the electric power conversion system 1 may include the high voltage battery BH, the switches SW1 and SW2, the capacitor 9, the switching circuit 12, and the driving circuit 32. Secondary-side circuitry of the electric power conversion system 1 may include the rectifying circuit 14, the smoothing circuit 15, the voltage sensor 18, the driving circuit 34, and the low voltage battery BL.

The terminals T11 and T12 may be configured to receive a voltage from the high voltage battery BH when the switches SW1 and SW2 are turned on. In the electric power conversion apparatus 10, the terminal T11 may be coupled to a voltage line L11, and the terminal T12 may be coupled to a reference voltage line L12. A voltage at the voltage line L11 with respect to a voltage at the reference voltage line L12 may be a voltage VH.

The switching circuit 12 may be configured to convert a direct-current voltage supplied from the high voltage battery BH into an alternating-current voltage. The switching circuit 12 may be a full-bridge circuit, and may include transistors S1 to S4. The transistors S1 to S4 may be switching devices that perform switching operations, respectively based on gate signals GA to GD. The transistors S1 to S4 may each include an N-type field-effect transistor (FET), for example. The transistors S1 to S4 may each include a body diode. For example, the body diode of the transistor S1 may include an anode coupled to a source of a body of the transistor S1, and a cathode coupled to a drain of the body of the transistor S1. This similarly applies to the transistors S2 to S4. Note that such a configuration is non-limiting. In some embodiments, an external diode device may be provided between the drain and the source of each of the transistors S1 to S4. Although the N-type field-effect transistor may be used in this example embodiment, this is non-limiting, and any kind of switching device may be used.

The transistor S1 may be provided in a path coupling the voltage line L11 and a node N1 to each other, and may be configured to couple the node N1 to the voltage line L11 when turned on. The drain of the transistor S1 may be coupled to the voltage line L11, a gate of the transistor S1 may receive the gate signal GA, and the source of the transistor S1 may be coupled to the node N1. The transistor S2 may be provided in a path coupling the node N1 and the reference voltage line L12 to each other, and may be configured to couple the node N1 to the reference voltage line L12 when turned on. The drain of the transistor S2 may be coupled to the node N1, a gate of the transistor S2 may receive the gate signal GB, and the source of the transistor S2 may be coupled to the reference voltage line L12.

The transistor S3 may be provided in a path coupling the voltage line L11 and a node N2 to each other, and may be configured to couple the node N2 to the voltage line L11 when turned on. The drain of the transistor S3 may be coupled to the voltage line L11, a gate of the transistor S3 may receive the gate signal GC, and the source of the transistor S3 may be coupled to the node N2. The transistor S4 may be provided in a path coupling the node N2 and the reference voltage line L12 to each other, and may be configured to couple the node N2 to the reference voltage line L12 when turned on. The drain of the transistor S4 may be coupled to the node N2, a gate of the transistor S4 may receive the gate signal GD, and the source of the transistor S4 may be coupled to the reference voltage line L12.

The transformer 13 may be configured to provide direct-current isolation and alternating-current coupling between the primary-side circuitry and the secondary-side circuitry, and configured to convert an alternating-current voltage supplied from the primary-side circuitry with a transformation ratio N of the transformer 13 and supply the converted alternating-current voltage to the secondary-side circuitry. The transformer 13 may include windings 13A and 13B. The winding 13A may be a primary winding. The winding 13A may have a first end coupled to the node N1 in the switching circuit 12, and a second end coupled to the node N2 in the switching circuit 12. The winding 13B may be a secondary winding. The winding 13B may have a first end coupled to a node N4 in the rectifying circuit 14, and a second end coupled to a node N5 in the rectifying circuit 14. The nodes N4 and N5 will be described later.

The rectifying circuit 14 may be configured to rectify an alternating-current voltage supplied from the winding 13B of the transformer 13. The rectifying circuit 14 may be a full-bridge circuit, and may include transistors S5 to S8. The transistors S5 to S8 may each be configured to perform a switching operation, based on a gate signal GE or GF. The transistors S5 to S8 may each include, for example, an N-type field-effect transistor, as with each of the transistors S1 to S4 of the switching circuit 12. The transistors S5 to S8 may each include a body diode, as with each of the transistors S1 to S4.

The transistor S5 may be provided in a path coupling a voltage line L21A and the node N4 to each other, and may be configured to couple the node N4 to the voltage line L21A when turned on. The transistor S5 may include a drain coupled to the voltage line L21A, a gate adapted to receive the gate signal GF, and a source coupled to the node N4. The transistor S6 may be provided in a path coupling the node N4 and a reference voltage line L22 to each other, and may be configured to couple the node N4 to the reference voltage line L22 when turned on. The transistor S6 may include a drain coupled to the node N4, a gate adapted to receive the gate signal GE, and a source coupled to the reference voltage line L22.

The transistor S7 may be provided in a path coupling the voltage line L21A and the node N5 to each other, and may be configured to couple the node N5 to the voltage line L21A when turned on. The transistor S7 may include a drain coupled to the voltage line L21A, a gate adapted to receive the gate signal GE, and a source coupled to the node N5. The transistor S8 may be provided in a path coupling the node N5 and the reference voltage line L22 to each other, and may be configured to couple the node N5 to the reference voltage line L22 when turned on. The transistor S8 may include a drain coupled to the node N5, a gate adapted to receive the gate signal GF, and a source coupled to the reference voltage line L22.

The smoothing circuit 15 may be configured to smooth a voltage rectified by the rectifying circuit 14. The smoothing circuit 15 may include a choke inductor 16 and a capacitor 17. The choke inductor 16 may have a first end coupled to the voltage line L21A, and a second end coupled to a voltage line L21B. The capacitor 17 may have a first end coupled to the voltage line L21B, and a second end coupled to the reference voltage line L22. Although the choke inductor 16 may be provided on the voltage lines L21A and L21B in the example embodiment, this is non-limiting. In some embodiments, the choke inductor 16 may be provided on the reference voltage line L22, for example.

The voltage sensor 18 may be configured to detect a voltage at the voltage line L21B. The voltage sensor 18 may have a first end coupled to the voltage line L21B, and a second end coupled to the reference voltage line L22. A voltage at the voltage line L21B with respect to a voltage at the reference voltage line L22 may be a voltage VL. The voltage sensor 18 may detect the voltage VL, and may supply a detection voltage VL2 corresponding to the voltage VL to the control circuit 40.

The auxiliary power supply circuit 20 may be configured to generate, based on the voltages VH and VL, various power supply voltages to be used in the electric power conversion apparatus 10, and to generate a detection voltage VH2 proportional to the voltage VH.

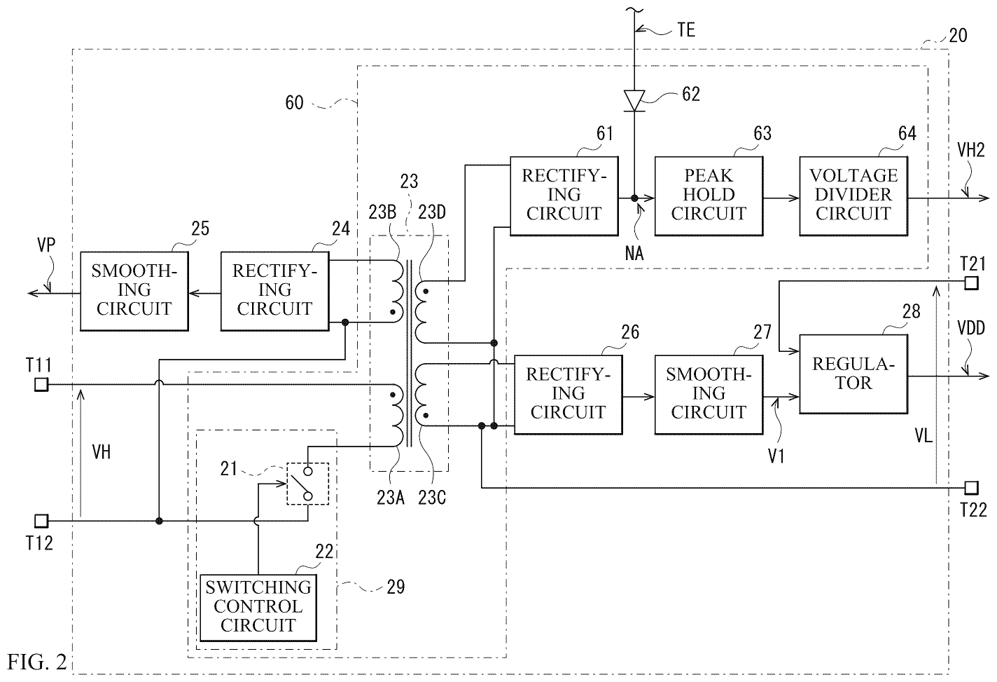

FIG. 2 illustrates a configuration example of the auxiliary power supply circuit 20. The auxiliary power supply circuit 20 may include a switching device 21, a switching control circuit 22, a transformer 23, a rectifying circuit 24, a smoothing circuit 25, a rectifying circuit 26, a smoothing circuit 27, a regulator 28, a rectifying circuit 61, a diode 62, a peak hold circuit 63, and a voltage divider circuit 64. The switching device 21, the switching control circuit 22, the transformer 23, the rectifying circuit 61, the diode 62, the peak hold circuit 63, and the voltage divider circuit 64 may configure a voltage detection circuit 60.

The switching device 21 may have a first end coupled to a winding 23A of the transformer 23, and a second end coupled to the terminal T12. The winding 23A will be described later. The switching control circuit 22 may be configured to control an operation of the switching device 21. The switching device 21 and the switching control circuit 22 may configure a switching circuit 29.

The transformer 23 may include the winding 23A and windings 23B, 23C, and 23D. The windings 23A and 23B may be primary windings, and the windings 23C and 23D may be secondary windings. The winding 23A may have a first end coupled to the terminal T11, and a second end coupled to the first end of the switching device 21. The winding 23B may have a first end and a second end both coupled to the rectifying circuit 24. The first end of the winding 23B may be coupled to the terminal T12. The winding 23C may have a first end and a second end both coupled to the rectifying circuit 26. The winding 23D may have a first end and a second end both coupled to the rectifying circuit 61. The first end of the winding 23C and the first end of the winding 23D may be coupled to the terminal T22.

The rectifying circuit 24 may be configured to rectify an alternating-current voltage outputted from the winding 23B of the transformer 23. The auxiliary power supply circuit 20 may cause a pulse voltage generated through a switching operation performed by the switching device 21 to be transmitted from the winding 23A to the winding 23B. The winding 23B and the rectifying circuit 24 may transmit electric power in a flyback manner. The smoothing circuit 25 may be configured to smooth a voltage rectified by the rectifying circuit 24 and to output a smoothed direct-current voltage as a power supply voltage VP. The auxiliary power supply circuit 20 may supply the power supply voltage VP to the driving circuit 32, as illustrated in FIG. 1.

The rectifying circuit 26 may be configured to rectify an alternating-current voltage outputted from the winding 23C of the transformer 23. The auxiliary power supply circuit 20 may cause the pulse voltage generated through the switching operation performed by the switching device 21 to be transmitted from the winding 23A to the winding 23C. The winding 23C and the rectifying circuit 26 may transmit electric power in the flyback manner. The smoothing circuit 27 may be configured to smooth a voltage rectified by the rectifying circuit 26 and to output a smoothed direct-current voltage as a voltage V1.

The regulator 28 may be configured to generate a power supply voltage VDD, based on either the voltage V1 or the voltage VL. For example, when the voltage V1 is lower than a desired voltage, the regulator 28 may generate the power supply voltage VDD, based on the voltage VL. When the voltage V1 is equal to the desired voltage, the regulator 28 may generate the power supply voltage VDD, based on the voltage V1. Thereafter, as illustrated in FIG. 1, the auxiliary power supply circuit 20 may supply the power supply voltage VDD to the control circuit 40.

The rectifying circuit 61 may be configured to rectify an alternating-current voltage outputted from the winding 23D of the transformer 23. The auxiliary power supply circuit 20 may cause the pulse voltage generated through the switching operation performed by the switching device 21 to be transmitted from the winding 23A to the winding 23D. The winding 23D and the rectifying circuit 61 may transmit electric power in a forward manner. The diode 62 may include an anode adapted to receive a control signal TE generated by the control circuit 40, and a cathode coupled to a node NA serving as an output node of the rectifying circuit 61. The control signal TE may transition between the power supply voltage VDD at the control circuit 40 and a ground voltage VGND, for example. The peak hold circuit 63 may be configured to perform a peak hold operation, based on a voltage at the node NA, and to thereby generate a voltage corresponding to a peak value of an output voltage of the rectifying circuit 61. The voltage divider circuit 64 may be configured to generate the detection voltage VH2 by dividing an output voltage of the peak hold circuit 63. The detection voltage VH2 may be proportional to the voltage VH. As illustrated in FIG. 1, the auxiliary power supply circuit 20 may supply the detection voltage VH2 to the control circuit 40.

The driving circuit 32 illustrated in FIG. 1 may be configured to operate based on the power supply voltage VP supplied from the auxiliary power supply circuit 20, and to generate the gate signals GA to GD, respectively based on gate signals GA1 to GD1 supplied from the control circuit 40.

The driving circuit 34 may be configured to operate with the voltage VL as a power supply voltage, and to generate the gate signals GE and GF, respectively based on gate signals GE1 and GF1 supplied from the control circuit 40. Although the driving circuit 34 may operate with the voltage VL as the power supply voltage in the example embodiment, this is non-limiting. In some embodiments, the driving circuit 34 may operate based on the power supply voltage VDD generated by the auxiliary power supply circuit 20.

The control circuit 40 may be configured to control an operation of the electric power conversion apparatus 10 by controlling operations of the switching circuit 12 and the rectifying circuit 14, based on the detection voltage VH2 supplied from the auxiliary power supply circuit 20, the detection voltage VL2 supplied from the voltage sensor 18, and control data CTL supplied from the unillustrated system control processor. For example, the control circuit 40 may control the operation of the electric power conversion apparatus 10 by generating the gate signals GA1 to GF1, based on the detection voltages VH2 and VL2, and performing pulse width modulation (PWM) control, based on the gate signals GA1 to GF1. Further, as will be described later, the control circuit 40 may be configured to diagnose the voltage detection circuit 60, based on the detection voltage VH2, through the use of the control signal TE. The control circuit 40 may operate based on the power supply voltage VDD supplied from the auxiliary power supply circuit 20. The control circuit 40 may include a microcontroller, for example.

The terminals T21 and T22 may be configured to supply a voltage generated by the electric power conversion apparatus 10 to the low voltage battery BL. In the electric power conversion apparatus 10, the terminal T21 may be coupled to the voltage line L21B, and the terminal T22 may be coupled to the reference voltage line L22. Further, the terminal T21 may be coupled to a positive terminal of the low voltage battery BL, and the terminal T22 may be coupled to a negative terminal of the low voltage battery BL.

The low voltage battery BL may be configured to store the electric power supplied from the electric power conversion apparatus 10.

This configuration allows the electric power conversion system 1 to perform an electric power conversion operation of converting electric power supplied from the high voltage battery BH and supplying the converted electric power to the low voltage battery BL.

Further, the electric power conversion system 1 may also have a capability of performing what is called a precharge operation, that is, an operation of charging the capacitor 9 in a period before starting the electric power conversion operation described above. In the precharge operation, the switches SW1 and SW2 may be off, and the control circuit 40 may control the operations of the switching circuit 12 and the rectifying circuit 14 to thereby allow the electric power conversion system 1 to supply electric power of the low voltage battery BL to the capacitor 9. This helps to reduce, in the electric power conversion apparatus 10, an inrush current flowing from the high voltage battery BH to the capacitor 9 when the switches SW1 and SW2 are turned on to perform the electric power conversion operation.

Here, the terminals T11 and T12 may correspond to a specific but non-limiting example of a “first electric power terminal” in one embodiment of the disclosure. The switching circuit 12 may correspond to a specific but non-limiting example of a “first switching circuit” in one embodiment of the disclosure. The transformer 13 may correspond to a specific but non-limiting example of a “first transformer” in one embodiment of the disclosure. The winding 13A may correspond to a specific but non-limiting example of a “first winding” of the “first transformer” in one embodiment of the disclosure. The winding 13B may correspond to a specific but non-limiting example of a “second winding” of the “first transformer” in one embodiment of the disclosure. The rectifying circuit 14 may correspond to a specific but non-limiting example of a “first rectifying circuit” in one embodiment of the disclosure. The smoothing circuit 15 may correspond to a specific but non-limiting example of a “smoothing circuit” in one embodiment of the disclosure. The terminals T21 and T22 may correspond to a specific but non-limiting example of a “second electric power terminal” in one embodiment of the disclosure. The voltage detection circuit 60 may correspond to a specific but non-limiting example of a “voltage detection circuit” in one embodiment of the disclosure. A node of the terminal T11 may correspond to a specific but non-limiting example of a “first node” in one embodiment of the disclosure. The node NA may correspond to a specific but non-limiting example of a “second node” in one embodiment of the disclosure. The control circuit 40 may correspond to a specific but non-limiting example of a “control circuit” in one embodiment of the disclosure.

The switching circuit 29 may correspond to a specific but non-limiting example of a “second switching circuit” in one embodiment of the disclosure. The transformer 23 may correspond to a specific but non-limiting example of a “second transformer” in one embodiment of the disclosure. The winding 23A may correspond to a specific but non-limiting example of a “first winding” of the “second transformer” in one embodiment of the disclosure. The winding 23D may correspond to a specific but non-limiting example of a “second winding” of the “second transformer” in one embodiment of the disclosure. The rectifying circuit 61 may correspond to a specific but non-limiting example of a “second rectifying circuit” in one embodiment of the disclosure. The peak hold circuit 63 may correspond to a specific but non-limiting example of a “peak hold circuit” in one embodiment of the disclosure. The diode 62 may correspond to a specific but non-limiting example of a “diode” in one embodiment of the disclosure.

The high voltage battery BH may correspond to a specific but non-limiting example of a “first battery” in one embodiment of the disclosure. The capacitor 9 may correspond to a specific but non-limiting example of a “capacitor” in one embodiment of the disclosure. The switch SW1 may correspond to a specific but non-limiting example of a “first switch” in one embodiment of the disclosure. The switch SW2 may correspond to a specific but non-limiting example of a “second switch” in one embodiment of the disclosure. The terminal T11 may correspond to a specific but non-limiting example of a “first coupling terminal” in one embodiment of the disclosure. The terminal T12 may correspond to a specific but non-limiting example of a “second coupling terminal” in one embodiment of the disclosure. The low voltage battery BL may correspond to a specific but non-limiting example of a “second battery” in one embodiment of the disclosure.

### <Operation and Workings>

Next, a description will be given of operation and workings of the electric power conversion system 1 according to the example embodiment.

### <Outline of Overall Operation>

First, an outline of an overall operation of the electric power conversion system 1 will be described with reference to FIG. 1. When the electric power conversion system 1 starts up, the switches SW1 and SW2 may be off. Upon start-up of the electric power conversion system 1, the switching circuit 29 of the auxiliary power supply circuit 20 may start a switching operation to generate the power supply voltages VP and VDD and generate the detection voltage VH2 proportional to the voltage VH. In a precharge period, the control circuit 40 may generate the gate signals GA1 to GF1, based on the detection voltage VH2, the detection voltage VL2 corresponding to the voltage VL, and the control data CTL. The electric power conversion apparatus 10 may perform switching operations, based on the gate signals GA to GF corresponding to the gate signals GA1 to GF1, and may thereby supply electric power of the low voltage battery BL to the capacitor 9. As a result, the capacitor 9 may be charged, and the voltage VH may rise to be maintained at or near a voltage value indicated by a target voltage command value VHtarget. Thereafter, in an electric power conversion period, the switches SW1 and SW2 may be turned on, and the control circuit 40 may generate the gate signals GA1 to GF1, based on the detection voltages VH2 and VL2. The electric power conversion apparatus 10 may perform switching operations, based on the gate signals GA to GF corresponding to the gate signals GA1 to GF1, and may thereby convert electric power supplied from the high voltage battery BH and supply the converted electric power to the low voltage battery BL.

### <Detailed Operation>

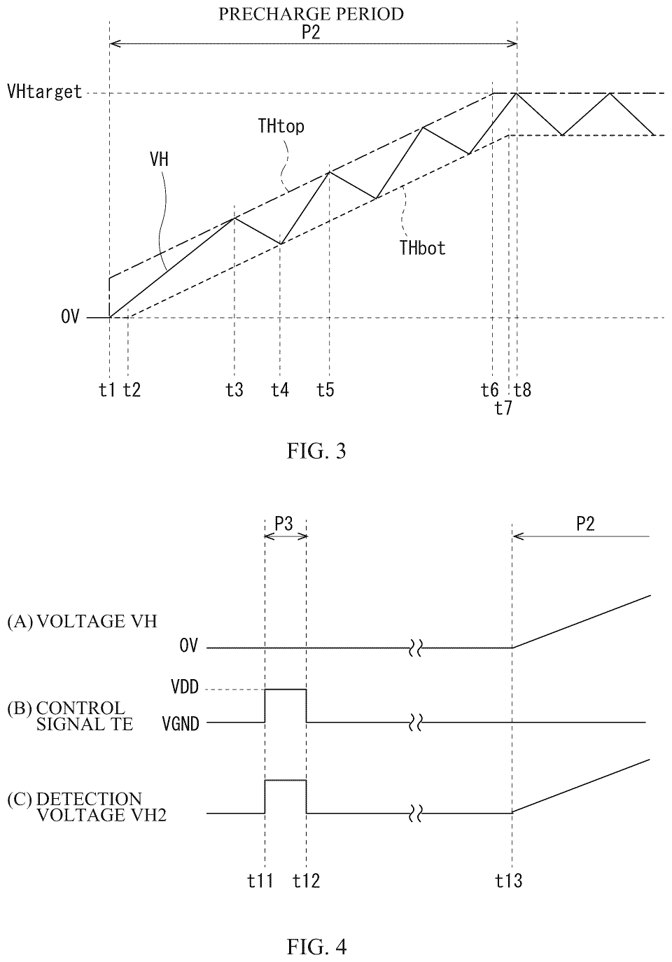

FIG. 3 illustrates an example of the precharge operation to be performed by the electric power conversion system 1.

In a precharge period P2 during which the precharge operation is to be performed, the control circuit 40 may generate thresholds THtop and THbot to cause the thresholds THtop and THbot to gradually increase. In this example, the control circuit 40 may cause the threshold THtop to linearly increase with the passage of time from a timing t1 when the precharge period P2 starts onward, and may cause the threshold THtop to stop changing at and after a timing t6. At and after the timing t6, the threshold THtop may be at a value equal to the target voltage command value VHtarget. Although the value of the threshold THtop at and after the timing t6 may be equal to the target voltage command value VHtarget in this example, this is non-limiting. In some embodiments, the value of the threshold THtop at and after the timing t6 may be equal to the target voltage command value VHtarget plus a value ΔV, i.e., VHtarget+ΔV. Here, ΔV may be any value corresponding to the target voltage command value VHtarget. Further, the control circuit 40 may cause the threshold THbot to linearly increase with the passage of time from a timing t2 following the timing t1 onward, and may cause the threshold THbot to stop changing at and after a timing t7 following the timing t6.

In the precharge period P2, the control circuit 40 may control the operation of the electric power conversion apparatus 10 to cause the voltage VH to fall within a voltage range between the threshold THbot and the threshold THtop both inclusive. For example, the control circuit 40 may set duty ratios of the switching circuit 12 and the rectifying circuit 14 to cause the voltage VH to rise during a period from the timing t1 to a timing t3. Thereafter, when the voltage VH reaches the threshold THtop at the timing t3, the control circuit 40 may set the duty ratios of the switching circuit 12 and the rectifying circuit 14 to cause the voltage VH to drop during a period from the timing t3 to a timing t4. Thereafter, when the voltage VH reaches the threshold THbot at the timing t4, the control circuit 40 may set the duty ratios of the switching circuit 12 and the rectifying circuit 14 to cause the voltage VH to rise during a period from the timing t4 to a timing t5. The control circuit 40 may repeat such operations from the timing t5 onward. In this way, in the precharge period P2, the voltage VH may rise toward the target voltage command value VHtarget, and may reach the target voltage command value VHtarget at a timing t8 in this example. In a period after the precharge period P2, the voltage VH may be maintained at or near the target voltage command value VHtarget.

Thereafter, the switches SW1 and SW2 may be turned on to couple the high voltage battery BH to the capacitor 9. The electric power conversion period, i.e., a period during which the electric power conversion system 1 is to perform the electric power conversion operation, may thus start. In the electric power conversion period, the electric power conversion system 1 may convert electric power supplied from the high voltage battery BH and supply the converted electric power to the low voltage battery BL.

### <Diagnosis on Voltage Detection Circuit 60>

The control circuit 40 diagnoses the voltage detection circuit 60 in a period before the precharge period P2. This operation will be described below.

FIG. 4 illustrates an example of the operation of diagnosing the voltage detection circuit 60. In FIG. 4, part (A) illustrates a waveform of the voltage VH, part (B) illustrates a waveform of the control signal TE, and part (C) illustrates a waveform of the detection voltage VH2.

Before the precharge period P2, the voltage VH may be 0 V, as illustrated in part (A) of FIG. 4. A voltage at the node NA serving as the output node of the rectifying circuit 61 in the auxiliary power supply circuit 20 may thus be the ground voltage VGND. The regulator 28 of the auxiliary power supply circuit 20 may generate the power supply voltage VDD, based on the voltage VL. The control circuit 40 may operate based on the power supply voltage VDD.

At a timing t11 before the precharge period P2, the control circuit 40 may cause a voltage of the control signal TE to change from the ground voltage VGND to the power supply voltage VDD, as illustrated in part (B) of FIG. 4. Thus, in the auxiliary power supply circuit 20, during a period P3 from the timing t11 to a timing t12, the diode 62 may be on and the voltage at the node NA may be at a value corresponding to the power supply voltage VDD. For example, the voltage at the node NA may be lower than the power supply voltage VDD by a forward voltage of the diode 62. As a result, the detection voltage VH2 may be at a value corresponding to the voltage at the node NA, as illustrated in part (C) of FIG. 4.

Based on the detection voltage VH2, the control circuit 40 may diagnose whether the voltage detection circuit 60 is operating normally. Because the voltage at the node NA is known, the detection voltage VH2 is also known. The control circuit 40 may thus determine whether the detection voltage VH2 is about the same as the known voltage to thereby diagnose whether the voltage detection circuit 60 is operating normally.

Thereafter, at the timing t12, the control circuit 40 may cause the voltage of the control signal TE to change from the power supply voltage VDD to the ground voltage VGND, as illustrated in part (B) of FIG. 4. This may turn off the diode 62 and cause the detection voltage VH2 to return to the value before the timing t11, as illustrated in part (C) of FIG. 4.

Thereafter, the electric power conversion system 1 may perform the precharge operation in the precharge period P2 starting at a timing t13. The precharge operation may cause the voltage VH to rise as illustrated in part (A) of FIG. 4, and may cause the detection voltage VH2 to rise with the voltage VH, as illustrated in part (C) of FIG. 4.

Here, the electric power conversion period may correspond to a specific but non-limiting example of a “first period” in one embodiment of the disclosure. The precharge period P2 may correspond to a specific but non-limiting example of a “second period” in one embodiment of the disclosure. The period P3 may correspond to a specific but non-limiting example of a “third period” in one embodiment of the disclosure.

As described above, in the period P3 before the precharge period P2, the electric power conversion system 1 may apply a predetermined voltage to the node NA and carry out a diagnosis, based on the detection voltage VH2 obtained at that time, as to whether the voltage detection circuit 60 is operating normally. This helps to allow the electric power conversion system 1 to effectively diagnose the voltage detection circuit 60.

For example, in the period P3 before the precharge period P2, the voltage VH may be 0 V and accordingly, if the predetermined voltage is not applied to the node NA, the detection voltage VH2 may be at a value corresponding to this value of the voltage VH, i.e., 0 V. Such a value of the detection voltage VH2 may be the same as a value of the detection voltage VH2 when the voltage detection circuit 60 malfunctions. Accordingly, in such a case, the voltage detection circuit 60 may not be diagnosable based on the detection voltage VH2.

In the precharge period P2, the detection voltage VH2 may rise with the voltage VH. It may thus be possible for the control circuit 40 to diagnose the voltage detection circuit 60 based on the detection voltage VH2. In such a case, however, if the voltage detection circuit 60 malfunctions, for example, it would be difficult for the control circuit 40 to timely detect abnormality of the voltage detection circuit 60. For example, at a point in time when the control circuit 40 detects the abnormality of the voltage detection circuit 60, the voltage VH can already be at a high value.

The electric power conversion system 1 according to the example embodiment may, in the period P3 before the precharge period P2, apply a predetermined voltage to the node NA and carry out a diagnosis, based on the detection voltage VH2 obtained at that time, as to whether the voltage detection circuit 60 is operating normally. This helps to allow the control circuit 40 to detect, for example, abnormality of the voltage detection circuit 60 before the voltage VH starts rising. As a result, the electric power conversion system 1 helps to effectively diagnose the voltage detection circuit 60.

As described above, the electric power conversion system 1 includes the first electric power terminal (the terminals T11 and T12), the first switching circuit (the switching circuit 12), the first transformer (the transformer 13), the first rectifying circuit (the rectifying circuit 14), the smoothing circuit 15, the second electric power terminal (the terminals T21 and T22), the voltage detection circuit 60, and the control circuit 40. The first switching circuit (the switching circuit 12) is coupled to the first electric power terminal (the terminals T11 and T12) and configured to perform a switching operation. The first transformer (the transformer 13) includes the first winding (the winding 13A) and the second winding (the winding 13B). The first winding (the winding 13A) is coupled to the first switching circuit (the switching circuit 12). The first rectifying circuit (the rectifying circuit 14) is configured to rectify a voltage supplied from the second winding (the winding 13B) of the first transformer (the transformer 13), by performing a switching operation. The smoothing circuit 15 is coupled to the first rectifying circuit (the rectifying circuit 14). The second electric power terminal (the terminals T21 and T22) is coupled to the smoothing circuit 15. The voltage detection circuit 60 includes the input node and the output node. The input node is coupled to the first node (the terminal T11 in the example embodiment) in the electric power conversion apparatus 10. The output node is configured to output a voltage corresponding to a voltage at the first node. The voltage detection circuit 60 is configured to apply a predetermined voltage to the second node (the node NA) in the signal path coupling the input node and the output node to each other. The control circuit 40 is configured to control the operation of each of the voltage detection circuit 60, the first switching circuit (the switching circuit 12), and the first rectifying circuit (the rectifying circuit 14). The control circuit 40 is configured to, in the second period (the precharge period P2) before the first period (the electric power conversion period) in which electric power is to be supplied from the first electric power terminal (the terminals T11 and T12) toward the second electric power terminal (the terminals T21 and T22), control the switching operation of the first switching circuit (the switching circuit 12) and the switching operation of the first rectifying circuit (the rectifying circuit 14) to cause electric power to be supplied from the second electric power terminal (the terminals T21 and T22) toward the first electric power terminal (the terminals T11 and T12). The control circuit 40 is configured to, in the third period (the period P3) before the second period (the precharge period P2), control the operation of the voltage detection circuit 60 to cause the predetermined voltage to be applied to the second node (the node NA), and diagnose the voltage detection circuit 60, based on a voltage (the detection voltage VH2) at the output node of the voltage detection circuit 60 in the third period (the period P3). In the electric power conversion system 1, this helps to allow the control circuit 40 to detect, for example, abnormality of the voltage detection circuit 60 before the voltage VH starts rising. The electric power conversion system 1 thus helps to effectively diagnose the voltage detection circuit 60.

In some embodiments, the first node may include the first electric power terminal (the terminal T11 in the example embodiment), and the control circuit 40 may be configured to, in the second period (the precharge period P2), control the switching operation of the first switching circuit (the switching circuit 12) and the switching operation of the first rectifying circuit (the rectifying circuit 14), based on a voltage at the first electric power terminal (the terminal T11 in the example embodiment). This helps to allow the electric power conversion system 1 to first determine, in the period P3, that the voltage detection circuit 60 configured to detect the voltage VH is normally operating, and to thereafter perform the precharge operation in the precharge period P2, based on the detection voltage VH2 outputted from the voltage detection circuit 60 whose normal operation has been determined. The electric power conversion system 1 thus helps to increase reliability of the precharge operation.

### Example Effects

As described above, an electric power conversion apparatus and an electric power conversion system according to at least one embodiment of the disclosure each include a first electric power terminal, a first switching circuit, a first transformer, a first rectifying circuit, a smoothing circuit, a second electric power terminal, a voltage detection circuit, and a control circuit. The first switching circuit is coupled to the first electric power terminal and configured to perform a switching operation. The first transformer includes a first winding and a second winding. The first winding is coupled to the first switching circuit. The first rectifying circuit is configured to rectify a voltage supplied from the second winding of the first transformer, by performing a switching operation. The smoothing circuit is coupled to the first rectifying circuit. The second electric power terminal is coupled to the smoothing circuit. The voltage detection circuit includes an input node and an output node. The input node is coupled to a first node in the electric power conversion apparatus. The output node is configured to output a voltage corresponding to a voltage at the first node. The voltage detection circuit is configured to apply a predetermined voltage to a second node in a signal path coupling the input node and the output node to each other. The control circuit is configured to control an operation of each of the voltage detection circuit, the first switching circuit, and the first rectifying circuit. The control circuit is configured to, in a second period before a first period in which electric power is to be supplied from the first electric power terminal toward the second electric power terminal, control the switching operation of the first switching circuit and the switching operation of the first rectifying circuit to cause electric power to be supplied from the second electric power terminal toward the first electric power terminal. The control circuit is configured to, in a third period before the second period, control the operation of the voltage detection circuit to cause the predetermined voltage to be applied to the second node, and diagnose the voltage detection circuit, based on a voltage at the output node of the voltage detection circuit in the third period. This helps to effectively diagnose the voltage detection circuit.

In some embodiments, the first node may include the first electric power terminal, and the control circuit may be configured to, in the second period, control the switching operation of the first switching circuit and the switching operation of the first rectifying circuit, based on a voltage at the first electric power terminal. This helps to increase reliability of the precharge operation.

### Modification Example 1

In the foregoing example embodiment, the diode 62 may be provided in the voltage detection circuit 60; however, this is non-limiting. In some embodiments, a switch may be provided in the voltage detection circuit 60, instead of the diode 62. The present modification example will be described in detail below.

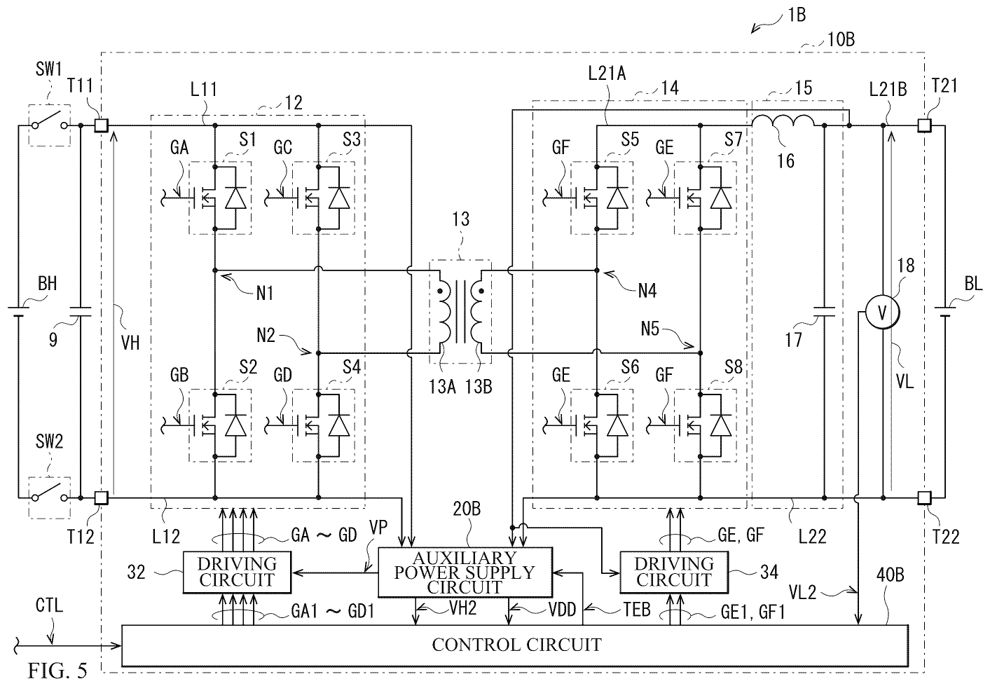

FIG. 5 illustrates a configuration example of an electric power conversion system 1B according to the present modification example. The electric power conversion system 1B includes an electric power conversion apparatus 10B. The electric power conversion apparatus 10B may include an auxiliary power supply circuit 20B and a control circuit 40B.

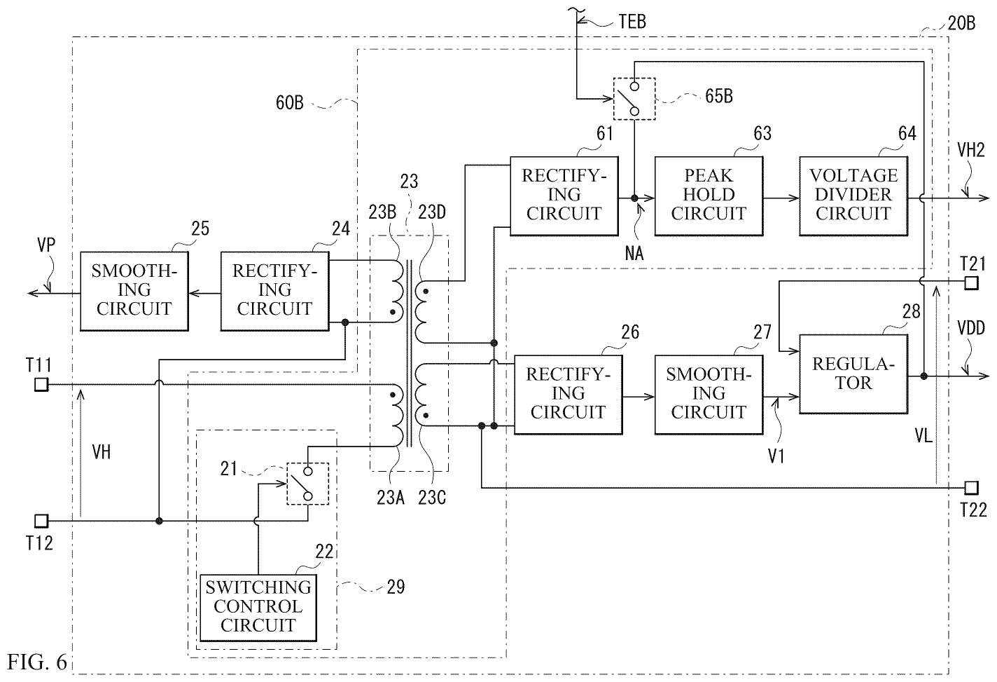

FIG. 6 illustrates a configuration example of the auxiliary power supply circuit 20B. The auxiliary power supply circuit 20B may include a switch 65B. Although the auxiliary power supply circuit 20 in the foregoing example embodiment illustrated in FIG. 2 may include the diode 62, the auxiliary power supply circuit 20B in the present modification example may include the switch 65B instead of the diode 62. The switch 65B may be configured to apply the power supply voltage VDD to the node NA, based on a control signal TEB generated by the control circuit 40B. The switch 65B may include a transistor, for example.

Here, the switch 65B may correspond to a specific but non-limiting example of a “switch” in one embodiment of the disclosure. A node of the power supply voltage VDD may correspond to a specific but non-limiting example of a “third node” in one embodiment of the disclosure.

The control circuit 40B may be configured to control the operation of the electric power conversion apparatus 10B by controlling the operations of the switching circuit 12 and the rectifying circuit 14, based on the detection voltage VH2 supplied from the auxiliary power supply circuit 20B, the detection voltage VL2 supplied from the voltage sensor 18, and the control data CTL supplied from the unillustrated system control processor. Further, the control circuit 40B may be configured to diagnose a voltage detection circuit 60B, based on the detection voltage VH2, through the use of the control signal TEB.

For example, in a period before the precharge period P2, the control circuit 40B may bring a voltage of the control signal TEB into a high level. In the auxiliary power supply circuit 20B, this may cause the switch 65B to be on and cause the voltage at the node NA to be equal to the power supply voltage VDD in the above-described period. As a result, the detection voltage VH2 may be at a value corresponding to the voltage at the node NA. This allows the control circuit 40B to carry out a diagnosis, based on the detection voltage VH2, as to whether the voltage detection circuit 60B is operating normally.

### Modification Example 2

In the foregoing example embodiment, the control circuit 40 may diagnose the voltage detection circuit 60 configured to detect the voltage VH; however, this is non-limiting. In some embodiments, the control circuit 40 may diagnose another voltage detection circuit configured to detect a voltage at another node in the electric power conversion apparatus 10. For example, the technology helps to diagnose a voltage detection circuit in a situation such as when a voltage to be inputted to the voltage detection circuit is 0 V. For example, before performing the precharge operation, no electric power may be supplied to the primary-side circuitry of the electric power conversion system 1. Accordingly, the technology is usable to diagnose a voltage detection circuit configured to detect a voltage at a node in the primary-side circuitry.

### Other Modification Examples

Any two or more of the foregoing modification examples may be employed in combination. Further, the disclosure encompasses any possible combination of some or all of the various embodiments described herein and incorporated herein.

The disclosure has been described hereinabove with reference to the example embodiment and the modification examples. However, the disclosure is not limited thereto, and various modifications may be made.

For example, in the foregoing example embodiment, the voltage detection circuit 60 may be diagnosed before starting of the precharge operation when the electric power conversion system 1 starts up; however, this is non-limiting. The electric power conversion system 1 may often perform precharge operations also after start-up. In such cases also, the electric power conversion system 1 may diagnose the voltage detection circuit 60 before each of such precharge operations.

For example, in the foregoing example embodiment, a step-down operation may be performed in the electric power conversion operation; however, this is non-limiting. In some embodiments, a step-up operation may be performed.

The effects described herein are mere examples, and effects of an embodiment of the disclosure are not limited thereto. Accordingly, any other effect may be obtained in relation to the embodiment of the disclosure.

An embodiment of the disclosure may have any of the following configurations.

(1)

An electric power conversion apparatus including:
a first electric power terminal;
a first switching circuit coupled to the first electric power terminal and configured to perform a switching operation;
a first transformer including a first winding and a second winding, the first winding being coupled to the first switching circuit;
a first rectifying circuit configured to rectify a voltage supplied from the second winding of the first transformer, by performing a switching operation;
a smoothing circuit coupled to the first rectifying circuit;
a second electric power terminal coupled to the smoothing circuit;
a voltage detection circuit including an input node and an output node, the input node being coupled to a first node in the electric power conversion apparatus, the output node being configured to output a voltage corresponding to a voltage at the first node, the voltage detection circuit being configured to apply a predetermined voltage to a second node in a signal path coupling the input node and the output node to each other; and
a control circuit configured to control an operation of each of the voltage detection circuit, the first switching circuit, and the first rectifying circuit, in which
the control circuit is configured to:
   in a second period before a first period in which electric power is to be supplied from the first electric power terminal toward the second electric power terminal, control the switching operation of the first switching circuit and the switching operation of the first rectifying circuit to cause electric power to be supplied from the second electric power terminal toward the first electric power terminal; and
   in a third period before the second period, control the operation of the voltage detection circuit to cause the predetermined voltage to be applied to the second node, and diagnose the voltage detection circuit, based on a voltage at the output node of the voltage detection circuit in the third period.
      (2)

The electric power conversion apparatus according to (1), in which
the first node includes the first electric power terminal, and
the control circuit is configured to, in the second period, control the switching operation of the first switching circuit and the switching operation of the first rectifying circuit, based on a voltage at the first electric power terminal.
   (3)

The electric power conversion apparatus according to (1) or (2), in which
the voltage detection circuit includes:
   a second switching circuit coupled to the input node and including a switching device configured to perform a switching operation;
   a second transformer including a first winding and a second winding, the first winding of the second transformer being coupled to the second switching circuit;
   a second rectifying circuit configured to rectify a voltage supplied from the second winding of the second transformer and configured to output a rectified voltage to the second node; and
   a peak hold circuit configured to perform a peak hold operation, based on a voltage at the second node, and
the voltage detection circuit is configured to output a voltage corresponding to an output voltage of the peak hold circuit from the output node.
   (4)

The electric power conversion apparatus according to any one of (1) to (3), in which
the voltage detection circuit includes a diode including an anode and a cathode, the cathode being coupled to the second node; and
the control circuit is configured to, in the third period, control the operation of the voltage detection circuit by applying a voltage corresponding to the predetermined voltage to the anode of the diode.
   (5)

The electric power conversion apparatus according to any one of (1) to (4), in which
the voltage detection circuit includes a switch configured to, when turned on, couple a third node supplied with the predetermined voltage to the second node, and
the control circuit is configured to, in the third period, control the operation of the voltage detection circuit by turning on the switch.
   (6)

An electric power conversion system including
a first battery including a first terminal and a second terminal,
a capacitor including a first terminal and a second terminal,
a first switch provided in a path coupling the first terminal of the first battery and the first terminal of the capacitor to each other,
a second switch provided in a path coupling the second terminal of the first battery and the second terminal of the capacitor to each other,
an electric power conversion apparatus, and
a second battery,
the electric power conversion apparatus including:
a first electric power terminal including a first coupling terminal and a second coupling terminal, the first coupling terminal being coupled to the first terminal of the capacitor, the second coupling terminal being coupled to the second terminal of the capacitor;
a first switching circuit coupled to the first electric power terminal and configured to perform a switching operation;
a first transformer including a first winding and a second winding, the first winding being coupled to the first switching circuit;
a first rectifying circuit configured to rectify a voltage supplied from the second winding of the first transformer, by performing a switching operation;
a smoothing circuit coupled to the first rectifying circuit;
a second electric power terminal coupled to the smoothing circuit and to the second battery;
a voltage detection circuit including an input node and an output node, the input node being coupled to a first node in the electric power conversion apparatus, the output node being configured to output a voltage corresponding to a voltage at the first node, the voltage detection circuit being configured to apply a predetermined voltage to a second node in a signal path coupling the input node and the output node to each other; and
a control circuit configured to control an operation of each of the voltage detection circuit, the first switching circuit, and the first rectifying circuit, in which
the control circuit is configured to:
   in a second period before a first period in which electric power is to be supplied from the first electric power terminal toward the second electric power terminal, control the switching operation of the first switching circuit and the switching operation of the first rectifying circuit to cause electric power to be supplied from the second electric power terminal toward the first electric power terminal; and
   in a third period before the second period, control the operation of the voltage detection circuit to cause the predetermined voltage to be applied to the second node, and diagnose the voltage detection circuit, based on a voltage at the output node of the voltage detection circuit in the third period.

An electric power conversion apparatus and an electric power conversion system according to at least one embodiment of the disclosure each make it possible to effectively diagnose a voltage detection circuit.

Although the disclosure has been described hereinabove in terms of the example embodiment and modification examples, the disclosure is not limited thereto. It should be appreciated that variations may be made in the described example embodiment and modification examples by those skilled in the art without departing from the scope of the disclosure as defined by the following claims.

The limitations in the claims are to be interpreted broadly based on the language employed in the claims and not limited to examples described in this specification or during the prosecution of the application, and the examples are to be construed as non-exclusive.

As used in this specification and the appended claims, the singular forms “a,” “an,” and “the” include, especially in the context of the claims, are to be construed to cover both the singular and the plural, unless otherwise indicated herein or clearly contradicted by context.

Throughout this specification and the appended claims, unless the context requires otherwise, the terms “comprise”, “include”, “have”, and their variations are to be construed to cover the inclusion of a stated element, integer or step but not the exclusion of any other non-stated element, integer or step.

The use of the terms first, second, etc. do not denote any order or importance, but rather the terms first, second, etc. are used to distinguish one element from another.

The term “substantially”, “approximately”, “about”, and its variants having the similar meaning thereto are defined as being largely but not necessarily wholly what is specified as understood by one of ordinary skill in the art.

The term “disposed on/provided on/formed on” and its variants having the similar meaning thereto as used herein refer to elements disposed directly in contact with each other or indirectly by having intervening structures therebetween.

What is claimed is:

1. An electric power conversion apparatus comprising:
a first electric power terminal;
a first switching circuit coupled to the first electric power terminal and configured to perform a switching operation;
a first transformer including a first winding and a second winding, the first winding being coupled to the first switching circuit;
a first rectifying circuit configured to rectify a voltage supplied from the second winding of the first transformer, by performing a switching operation;
a smoothing circuit coupled to the first rectifying circuit;
a second electric power terminal coupled to the smoothing circuit;
a voltage detection circuit including an input node and an output node, the input node being coupled to a first node in the electric power conversion apparatus, the output node being configured to output a voltage corresponding to a voltage at the first node, the voltage detection circuit being configured to apply a predetermined voltage to a second node in a signal path coupling the input node and the output node to each other; and
a control circuit configured to control an operation of each of the voltage detection circuit, the first switching circuit, and the first rectifying circuit, wherein
the control circuit is configured to:
in a second period before a first period in which electric power is to be supplied from the first electric power terminal toward the second electric power terminal, control the switching operation of the first switching circuit and the switching operation of the first rectifying circuit to cause electric power to be supplied from the second electric power terminal toward the first electric power terminal; and
in a third period before the second period, control the operation of the voltage detection circuit to cause the predetermined voltage to be applied to the second node, and diagnose the voltage detection circuit, based on a voltage at the output node of the voltage detection circuit in the third period.

2. The electric power conversion apparatus according to claim 1, wherein
the first node comprises the first electric power terminal, and
the control circuit is configured to, in the second period, control the switching operation of the first switching circuit and the switching operation of the first rectifying circuit, based on a voltage at the first electric power terminal.

3. The electric power conversion apparatus according to claim 1, wherein
the voltage detection circuit includes:
a second switching circuit coupled to the input node and including a switching device configured to perform a switching operation;
a second transformer including a first winding and a second winding, the first winding of the second transformer being coupled to the second switching circuit;
a second rectifying circuit configured to rectify a voltage supplied from the second winding of the second transformer and configured to output a rectified voltage to the second node; and
a peak hold circuit configured to perform a peak hold operation, based on a voltage at the second node, and
the voltage detection circuit is configured to output a voltage corresponding to an output voltage of the peak hold circuit from the output node.

4. The electric power conversion apparatus according to claim 1, wherein
the voltage detection circuit includes a diode including an anode and a cathode, the cathode being coupled to the second node; and
the control circuit is configured to, in the third period, control the operation of the voltage detection circuit by applying a voltage corresponding to the predetermined voltage to the anode of the diode.

5. The electric power conversion apparatus according to claim 1, wherein
the voltage detection circuit includes a switch configured to, when turned on, couple a third node supplied with the predetermined voltage to the second node, and
the control circuit is configured to, in the third period, control the operation of the voltage detection circuit by turning on the switch.

6. An electric power conversion system comprising
a first battery including a first terminal and a second terminal,
a capacitor including a first terminal and a second terminal,
a first switch provided in a path coupling the first terminal of the first battery and the first terminal of the capacitor to each other,
a second switch provided in a path coupling the second terminal of the first battery and the second terminal of the capacitor to each other,
an electric power conversion apparatus, and
a second battery,
the electric power conversion apparatus including:
a first electric power terminal including a first coupling terminal and a second coupling terminal, the first coupling terminal being coupled to the first terminal of the capacitor, the second coupling terminal being coupled to the second terminal of the capacitor;
a first switching circuit coupled to the first electric power terminal and configured to perform a switching operation;
a first transformer including a first winding and a second winding, the first winding being coupled to the first switching circuit;
a first rectifying circuit configured to rectify a voltage supplied from the second winding of the first transformer, by performing a switching operation;
a smoothing circuit coupled to the first rectifying circuit;
a second electric power terminal coupled to the smoothing circuit and to the second battery;
a voltage detection circuit including an input node and an output node, the input node being coupled to a first node in the electric power conversion apparatus, the output node being configured to output a voltage corresponding to a voltage at the first node, the voltage detection circuit being configured to apply a predetermined voltage to a second node in a signal path coupling the input node and the output node to each other; and
a control circuit configured to control an operation of each of the voltage detection circuit, the first switching circuit, and the first rectifying circuit, wherein
the control circuit is configured to:
in a second period before a first period in which electric power is to be supplied from the first electric power terminal toward the second electric power terminal, control the switching operation of the first switching circuit and the switching operation of the first rectifying circuit to cause electric power to be supplied from the second electric power terminal toward the first electric power terminal; and
in a third period before the second period, control the operation of the voltage detection circuit to cause the predetermined voltage to be applied to the second node, and diagnose the voltage detection circuit, based on a voltage at the output node of the voltage detection circuit in the third period.
